(19) United States
(12) Patent Application Publication
(10) Pub. No.: US 2017/0127710 A1
(43) Pub. Date: May 11, 2017

(54) COMPOSITIONS AND METHODS FOR DELIVERING TASTANTS

(71) Applicant: Intercontinental Great Brands LLC, East Hanover, NJ (US)

(72) Inventors: Ahmad Akashe, East Hanover, NJ (US); Renee Gan, East Hanover, NJ (US); Alicia Omans, East Hanover, NJ (US); Robert Magaletta, East Hanover, NJ (US)

(73) Assignee: Intercontinental Great Brands LLC, East Hanover, NJ (US)

(21) Appl. No.: 15/322,396

(22) PCT Filed: Jun. 29, 2015
(86) PCT No.: PCT/US2015/038276

§ 371 Date: Dec. 27, 2016

Related U.S. Application Data
(60) Provisional application No. 62/019,562, filed on Jul. 1, 2014.

(51) Int. Cl. A23L 27/40; A23P 20/18; A23L 27/00

(52) U.S. Cl. CPC A23L 27/40; A23L 27/72; A23P 20/18; A23V 2002/00

(57) ABSTRACT

A method of making a tastant composition may generally comprise granulating an edible carrier and a first tastant and coating the granules with a second tastant. A tastant composition may generally comprise a core including a mixture of an edible carrier and a first tastant, and a coating on the core, the coating comprising a second tastant, and optionally a binder. Each of the first tastant and second tastant may comprise sodium chloride particles. The tastant composition may provide a substitute for a conventional tastant topping with a comparable appearance, e.g., comparable particle size, color, and morphology, as well as a comparable taste profile (time v. flavor intensity), but with significantly lower tastant content.

### CROSS-REFERENCE TO RELATED APPLICATION

This application claims the benefit of U.S. provisional patent application No. 62/019,562, filed Jul. 1, 2014, which is incorporated herein in its entirety by reference.

### BACKGROUND

This application generally relates to tastant compositions for food products as well as methods of making and using them.

Taste is the sensory impression of food or other substances on the tongue. There are generally considered to be five categories of taste: sweet, sour, bitter, salty and umami (savory). Taste perception may include other sensations, such as, pungency (spiciness), coolness, numbness, astringency, metallicness, fattiness, mouthfeel, and temperature. A tastant is a compound or composition that may induce or elicit taste perception of one or more of the taste categories or other taste sensation. Tastants may be added to food products to improve the overall taste. For example, tastants may be added to food products to increase the appetitive salty, sweet, and umami tastes, decrease the aversive bitter and sour tastes, or adjust the other taste sensations. As described below, it may be desirable to achieve the desired taste of food products while reducing the level of tastant added to the food product.

Granular sodium chloride, commonly referred to as “salt” or “table salt”, is a tastant that may be provided in a visible form on the surfaces of many food products, such as potato chips, corn chips, other types of chips, pretzels, and crackers, to enhance their organoleptic properties. Sodium chloride is known to improve the perception of food thickness, enhance sweetness, decrease bitterness, and round out overall flavor while improving flavor intensity. Topical sodium chloride is often added to products such as those mentioned above to provide visual appeal and a salty taste. In conventional formulations, topical sodium chloride may contribute up to 50% of the total sodium content of a snack product.

When the sodium content of a snack food product is reduced, e.g., by reducing the amount of topical sodium chloride, the sensorial experience may be compromised and therefore, product quality and consumer liking may decrease. Conventional approaches to reduce sodium may replace up to 50% of sodium chloride by salt substitutes and other flavorings. Salt substitutes, such as salts of organic and non-organic acids, phosphates, citrates, and lactates, may be effective to impart a salty taste, but may also introduce undesirable flavor notes. For example, potassium chloride and/or magnesium chloride may impart a bitter, medicinal, and/or otherwise unpleasant taste to food products. Some salt potentiators and other flavorings that may enhance salty taste rely on extracts from natural sources that may also impart a meaty or umami taste. These conventional approaches tend to lack the distinct and uninhibited salty taste profile and intensity of sodium chloride. These conventional approaches also provide only limited sodium reduction.

There is a need for improved salt compositions having reduced sodium content that may be useful for topical application to food products.

### SUMMARY

In various embodiments, lower-sodium salt compositions, and methods of making and using them are described.

In various embodiments, a tastant composition may comprise fine tastant particles delivered within and/or on a surface of a granulated substrate for a topping application. The substrate may be a non-salt material. The tastant composition may provide a substitute for a conventional tastant topping with a comparable appearance, e.g., comparable particle size, color, and morphology, as well as a comparable taste profile (time v. flavor intensity), but with significantly lower tastant content.

In various embodiments, a tastant composition may generally comprise a core including a mixture of an edible carrier and a first tastant, and a coating on the core, the coating comprising a second tastant, and optionally a binder. The first and second tastants may be sodium chloride, and the carrier may be a non-salt material.

In various embodiments, a method of making a tastant composition may generally comprise granulating an edible carrier and a first tastant, and coating the granule with a second tastant. The first and second fine tastants may be sodium chloride, and the carrier may be a non-salt material.

### BRIEF DESCRIPTION OF THE DRAWING FIGURES

The various non-limiting embodiments described herein may be better understood by considering the following description in conjunction with one or more of the accompanying drawings.

FIG. 1 is a graph illustrating the dissolution rate of salt compositions according to various embodiments.

FIG. 2 is a chart illustrating sensory analysis of salt compositions according to various embodiments.

FIGS. 3 and 4 are graphs illustrating the dissolution rate of salt compositions according to various embodiments.

### DESCRIPTION

Most snack food products, such as chips, pretzels, and crackers, have a short mouth residence time of less than 30 seconds, such as 20 to 30 seconds, during which they are chewed before being swallowed. The sizes of the salt particles on the surfaces of such products may affect their dissolution rate. Conventional topical sodium chloride compositions may comprise large, dense, granular particles that are slow dissolving and not immediately soluble in saliva. When these particles are sprinkled onto foods, they generally provide low intensity, long lasting, and mild salty taste. As a result of the short mouth residence time, a significant portion of the sodium chloride may not completely dissolve and/or reach the taste buds before the food is swallowed. In addition, the large, dense, granular particles may form a highly concentrated solution when dissolved that may saturate local taste buds. In other words, conventional topical sodium chloride compositions may have a low efficiency in providing a salty taste.

On the other hand, extra fine sodium chloride particles, e.g., up to a particle size of 50 μm, may dissolve much faster and quickly provide an initial high intensity salty taste, but lack the long lasting, lingering salty taste and visual appeal of large, dense, granular particles. Extra fine sodium chloride particles generally have a smaller particle size and a higher ratio of surface area to sodium content relative to large, dense sodium chloride particles. Extra fine salt particles may provide increased interaction with saliva and sensory physiology in the mouth, e.g., tongue, cheeks, and gums, which may lead to an increased sensation of salty taste relative to the amount of salt in the particles. Extra fine salt particles may also provide more particles per unit area. As a result, the extra fine salt particles may have a greater initial salty taste relative to large, dense salt particles.

In various embodiments, a salt composition may comprise a core including a mixture of an edible, non-salt carrier and a first fine salt; and a coating on the core, the coating comprising a second fine salt, and optionally a binder. In some embodiments, the salt composition may not include any significant amounts of ingredients beyond those mentioned above. The first fine salt and second fine salt may each comprise a chloride salt selected from the group consisting of sodium chloride, potassium chloride, magnesium chloride, calcium chloride, lithium chloride, ammonium chloride, and a mixture thereof. The first fine salt and second fine salt may each comprise a crystalline salt. The first fine salt and second fine salt may each consist essentially of sodium chloride, i.e., they may comprise pure sodium chloride, or substantially pure sodium chloride accompanied only by small quantities of incidental impurities. Incidental impurities may include, but are not limited to, other chlorides and sulfates. In various embodiments, the salt composition may comprise, based on weight percent of the salt composition, at least 99.7% sodium chloride, up to 0.25% calcium sulfate, up to 0.12% other salts (e.g., calcium chloride, magnesium sulfate, magnesium chloride), up to 950 ppm calcium/magnesium, up to 0.1% moisture, up to 0.5 ppm copper, up to 1.0 ppm free iron, up to 1 ppm arsenic, up to 2 ppm metals (e.g., lead), and 1.4-2.0% tricalcium phosphate. In some embodiments, the composition may be free from salt substitutes, salt potentiators, and other flavorings.

In various embodiments, a tastant composition may comprise a core including a mixture of an edible, non-salt carrier and a first tastant; and a coating on the core, the coating comprising a second tastant, and optionally a binder. In various embodiments, the tastant composition may comprise at least one tastant selected from sweet, sour, bitter, salty, umami (savory), pungency (spiciness), coolness, numbness, astringency, metallicness, fattiness, and mouthfeel. In various embodiments, tastants may include salt compositions, natural sweeteners, and/or artificial sweeteners. In various embodiments, tastants may include, but are not limited to, chloride salts, sucrose, fructose, high fructose corn syrup, stevia, honey, Lo Han, molasses, malt syrup, aspartame, sucralose, acesulfame potassium (Ace-K), saccharin, cyclamate, fruity-type flavors, such as strawberry flavor, cheese flavors, yeast extracts, inactive yeast, herbal extracts, menthol, sugar alcohols, including, xylitol, erythritol, glycerol or glycerin or glycerine, hydrogenated starch hydrolysates, isomalt, lactitol, maltitol, mannitol, and sorbitol, monosodium glutamate, amino acids, including glutamic acid and aspartic acid, 5′-ribonucleotides, sodium lauryl sulfate, miraculin, lactisole, 6-methoxy-flavanones, and denatonium benzoate.

In various embodiments, the carrier and binder may individually comprise a starch or a starch derivative, such as a carbohydrate or sugar. The carrier and binder may individually comprise monosaccharides, disaccharides, and polysaccharides, and a mixture thereof. The carrier and binder may individually comprise glucose, fructose, galactose, sucrose, maltose, lactose, maltodextrin and a mixture thereof. The carrier may comprise lactose. The carrier may comprise maltodextrin. The maltodextrin may have a Dextrose equivalent (DE) of, e.g., less than 40, less than 20, less than 10, 1-40, 1-20, 1-10, 5-10, 1-5, 5, or 1. The carrier and binder may be the same or different. For example, the carrier may lack water and the binder may include water.

In various embodiments, the carrier may comprise lactose; the first fine salt and second fine salt may each comprise sodium chloride and incidental impurities; and the binder may comprise 1 DE maltodextrin. In various embodiments, the carrier may comprise lactose; the first fine salt and second fine salt may each comprise sodium chloride and incidental impurities; and the composition may lack a binder. In various embodiments, the carrier may comprise 1 DE maltodextrin; the first fine salt and second fine salt may each comprise sodium chloride and incidental impurities; and the binder may comprise 1 DE maltodextrin. In various embodiments, the carrier may comprise 1 DE maltodextrin, the first fine salt and second fine salt may each comprise sodium chloride and incidental impurities, and the composition may lack a binder.

In various embodiments, the composition may comprise at least 1, 5, 10, 15, 20, 25, 30, 35, 40, 45, 50, 55, 60, 65, 70, 75, 80, 85, 90, 95, 97, or 99 weight percent total tastant, not including the binder. More specifically, the composition may comprise 5-99, 25-85, 25-50, 50-80, 55-75, 60-70, 62-67, or 64-66 weight percent total tastant, not including the binder. The composition may comprise about 62-67 weight percent salt and about 33-38 weight percent carrier, not including the binder. The composition may comprise about 65 weight percent salt and about 35 weight percent carrier, not including the binder. The composition may comprise about 25 weight percent salt and about 75 weight percent carrier, not including the binder.

In some embodiments, the coating may comprise a binder in an amount effective to bind the coating to the core. In various embodiments, the tastant composition may comprise at least 25 weight percent total tastant including the sum of the first fine salt and second fine salt, and up to 10 weight percent binder. The composition may comprise at least 45, 50, 55, 60, 65, 70, 75, 80, 85, 90, 95, 97, or 99 weight percent total tastant, and an amount of binder, but no more than 10 weight percent. The composition may comprise 5-99, 25-85, 25-50, 50-80, 55-75, 60-70, 62-67, or 64-66 weight percent total tastant, and an amount of binder, but no more than 10 weight percent, such as less than 1, 1-10, 2-8, 4-6, 7-8, 6, 7, or 8 weight percent. In various embodiments, the salt composition may comprise at least 25 weight percent total salt including the sum of the first fine salt and second fine salt, and up to 10 weight percent binder. In the above embodiment, the salt may consist essentially of sodium chloride, and the composition may consist essentially of salt, binder, and carrier. In some embodiments, the composition may comprise at least 65 weight percent of total salt, an amount of binder, but no more than 8 weight percent, and an amount of carrier, but no more than 35 weight percent.

In some embodiments, the total salt may consist essentially of a first fine salt and second fine salt. The total salt may comprise up to 50 weight percent first fine salt. The total salt may comprise, up to 35, up to 25, up to 15, up to 50, 1-25, 1-15, 25, or 15 weight percent first fine salt. The total salt may comprise 25 weight percent first fine salt and 75 weight percent second fine salt. The total salt may comprise 15 weight percent first fine salt and 85 weight percent second fine salt. The total salt may comprise less than 1 weight percent of the first fine salt and at least 99 weight percent of the second fine salt.

In some embodiments, the total tastant may consist essentially of a first tastant and second tastant. The total tastant may comprise up to 50 weight percent first tastant. The total tastant may comprise, up to 35, up to 25, up to 15, up to 50, 1-25, 1-15, 25, or 15 weight percent first tastant. The total tastant may comprise 25 weight percent first tastant and 75 weight percent second tastant. The total tastant may comprise 15 weight percent first tastant and 85 weight percent second tastant. The total salt may comprise less than 1 weight percent of the first tastant and at least 99 weight percent of the second tastant.

In various embodiments, the total tastant may comprise a ratio, based on weight, of the second tastant to first tastant from greater than 1:1, at least 2:1, at least 3:1, at least 5:1, at least 10:1, and up to 100:1. The salt composition may comprise a ratio, based on weight, of the second tastant to first tastant of greater than 1:1 to 100:1, 2:1 to 20:1, 5:1 to 10:1, 13:2 to 13:9, 2:1, 3:1, 4:1, 5:1, 20:3, 10:1, 20:1, 100:3, and 100:1. The tastant composition may comprise a ratio, based on weight, of the second tastant to first tastant of 13:9. The tastant composition may comprise a ratio, based on weight, of the second tastant to first tastant of 13:2.

In various embodiments, the particle size of the first tastant may be greater than the particle size of the second tastant. The particle size may refer to a specific particle size or a particle size of a population of tastant particles having different sizes, i.e., average particle size. The first tastant and second tastant may independently comprise particles having a particle size of at least 400 mesh, such as, 140-400, 170-230, 200-400, 200-325, 270-400, 170, 200, 230, 270, 325, and 400 mesh, and mixtures thereof. The first tastant may have a particle size of 170-230 mesh and mixtures thereof, and the second tastant may independently have a particle size of 270-400 mesh and mixtures thereof. The first tastant may have a particle size of 200 mesh and the second tastant may have a particle size of 325 mesh. In various embodiments, at least one of the first tastant and second tastant may individually comprise a mixture of particles having a particle size of 200 mesh and 325 mesh. In various embodiments, the particle size of the first tastant and/or second tastant may be greater than the particle size of extra fine salt, e.g. greater than 50 μm. All mesh sizes are U.S. standard sieve sizes. Any maximum mesh size recited herein indicates that at least 90%, at least 95%, at least 99%, and at least 99.9% of the particles pass through the sieve and any minimum mesh size recited herein indicates that at least 90%, at least 95%, at least 99%, and at least 99.9% of the particles are retained by the sieve.

In various embodiments, first tastant and second tastant may independently comprise particles having a particle size at least 35 micrometers, such as 35-150 micrometers, 60-90 micrometers, 35-75 micrometers, 40-75 micrometers, 35-55 micrometers, 40-55 micrometers, 88 micrometers, 74 micrometers, 63 micrometers, 53 micrometers, 44 micrometers, and 37 micrometers. The first tastant may have a particle size of 75 micrometers and the second tastant may have a particle size of 44 micrometers. In various embodiments, the particle size of the first tastant and/or second tastant may be greater than the particle size of extra fine salt, e.g. greater than 50 μM.

In various embodiments, the tastant composition may comprise a ratio, based on weight, of 200 mesh to 385 mesh particles of greater than 1:1, at least 2:1, at least 3:1, at least 5:1, at least 10:1, or up to 100:1. The tastant composition may comprise a ratio, based on weight, of 200 mesh particulates to 325 mesh particles of 1:1 to 100:1, 2:1 to 20:1, 5:1 to 10:1, 13:2 to 13:9, 2:1, 3:1, 4:1, 5:1, 20:3, 10:1, 20:1, 100:3, or 100:1. The tastant composition may comprise a ratio, based on weight, of 200 mesh particles to 325 mesh particles of greater than 5:1. The tastant composition may comprise a ratio, based on weight, of 200 mesh particles to 325 mesh particles of 13:9. The tastant composition may comprise a ratio, based on weight, of 200 mesh to 325 mesh particles of 13:2.

In various embodiments, the second tastant may be deposited on at least a portion of the core. The second tastant may be adhered to the core via chemical ionic and/or covalent bonding, surface tension, adhesion, and/or any other physical processes. In various embodiments, the intensity of a tastant's flavor may be adjusted by controlling the ratio of the first tastant to the second tastant.

In various ‘embodiments, the tastant composition may have an average particle size from 10-3000 micrometers, 100-1500 micrometers, 100-900 micrometers, 100-450 micrometers, 450-1500 micrometers, 750-1200 micrometers, 1000-3000 micrometers, and 1500-2500 micrometers. In various embodiments, the salt composition may have an average particle size similar to conventional topical salt compositions, e.g. from 100 micrometers to 1500 micrometers, such as 100 micrometers to 900 micrometers. The salt composition may have an average particle size of greater than 35 mesh, greater than 60 mesh, greater than 80 mesh, or greater than 100 mesh. The salt composition may have a particle size from 14-80 mesh, 35-60 mesh. The tastant composition may be free flowing.

In various embodiments, the tastant composition may have a moisture content up to 5%. More specifically, the tastant composition may have a moisture content of up to 1%, 1-5%, 1-3%, 2-4%, 3%, 2%, or 1%.

In various embodiments, the first fine salt and second fine salt may be crystalline or substantially crystalline. The first fine salt and second fine salt may be free, mostly free, substantially free, or completely free of amorphous solids.

In various embodiments, the tastant composition may have less tastant per unit volume than an equivalent unit volume of tastant. The tastant composition may have a flavor intensity of the tastant that is about the same as that of a tastant composition comprising a greater weight percent of tastant. In various embodiments, the salt composition may have less sodium chloride per unit volume than an equivalent unit volume of sodium chloride. The salt composition may have a salt intensity that is about the same as that of a salt composition comprising a greater weight percent of sodium chloride. The salt composition may have an initial dissolution rate that is about the same and a lingering dissolution rate that is less than a dissolution rate of a salt composition comprising sodium chloride having a greater of particle size and/or weight per weight basis.

In various embodiments, the salt composition may have a baked stability greater than 50%, such as about 100%, at least 98%, at least 95%, at least 90%, 50-100%, 60-100%, 70-100%, 80-100%, 90-100%, 92-100%, 95-100%, 98-100%, 92%, 95%, 98%, 99%, and 100% baked stability, as measured by percent of the salt composition melting, browning, or burning when baked. As generally used herein, the term “baked stability” refers to a salt composition that retains the characteristics of salt, including the original color (e.g., no or minimal browning), crystallinity (i.e., no melting or burning), and 100% integrity as discrete particles, after baking in an oven at a temperature from 250-500° F. for 3-30 minutes. The oven may be a conventional oven, convection oven, deck oven, impingement oven, reel oven, rotary oven, or a tunnel oven. The tunnel oven may be a direct gas-fired (DGF), indirect gas-fired, convection, deck, or hybrid oven. The oven may utilize a gas, electric, infrared, microwave, or a hybrid heat source.

In various embodiments, a method of making a tastant composition may generally comprise granulating an edible, non-salt carrier and a first tastant; drying the granules to reduce the moisture content to less than 5%; coating the granules with a second tastant; and drying the coated granules to reduce the moisture content to less than 5% to obtain the tastant composition; wherein the tastant composition comprises a core including a mixture of the edible, non-salt carrier and first tastant, and a coating on the core, the coating comprising the second tastant, and optionally a binder.

In various embodiments, a method of making a salt composition may generally comprise granulating an edible, non-salt carrier and a first fine salt; drying the granules to reduce the moisture content to less than 5%; coating the granules with a second fine salt; and drying the coated granules to reduce the moisture content to less than 5% to obtain the composition; wherein the composition comprises a core including a mixture of the edible, non-salt carrier and first fine salt, and a coating on the core, the coating comprising the second fine salt, and optionally a binder. In various embodiments, the method may comprise milling a coarse salt to achieve the fine salt. Milling may comprise hammer milling. The mesh size for the screen may be selected to achieve the desired particle size as described above. After the course salt is milled, the milled particles may be dried, e.g., in the air, if desired.

The salt may be granulated using any suitable methods, such as fluidized bed coating, roller compaction, cold extrusion, and centrifugal fluid granulation. In various embodiments, the method may comprise fluidized bed coating to granulate the edible, non-salt carrier and first fine salt. In roller compaction, the edible, non-salt carrier and first fine salt may be dry blended and sprayed with a binder, e.g., water, to form a damp powder. The damp powder may be forced through and between two rollers to form a compacted material. The compacted material may be milled and shifted to a desired size, and dried. In cold extrusion, the edible, non-salt carrier and first fine salt may be dry blended and sprayed with a binder, e.g., water, to form a damp powder. The damp powder may be forced through a die with at least one hole to form a compacted material. The compacted material may be dried, milled, and shifted to a desired size. In centrifugal fluid granulation, the edible, non-salt carrier and first fine salt may be dry blended and rotated at 100-300 revolutions per minute (rpm) in a container. A binder solution, e.g., water, may be sprayed tangentially onto the rotating powder. Spraying may be stopped when the desired size is achieved. The granulated material may be dried by increasing the fluidizing air temperature. In various embodiments, the same equipment/process may be used for powder layering/coating the second fine salt.

Prior to granulation, a binder may be added to the salt to improve the granulation process. Optionally, water or other liquid may be added to aid the granulation process. The amount of water added generally depends on the granulation process. Water or other liquid may be added at any suitable time during the granulation process. For example, a binder may be mixed with a liquid, e.g., water, to form an aqueous solution or a homogeneous slurry, and the solution or slurry may be deposited onto the core as described below.

Any suitable methods may be used to deposit the coating onto the core, including, but not limited to, powder coating, spray drying, fluidized bed coating, including top-spray methods, bottom-spray methods, Wurster coating methods, tangential spray (rotary) method, roller compaction, granulation, and/or extrusion.

For example, wet granulation and dry granulation methods may be used. Dry granulation refers to granulation without the use of heat and solvent. Dry granulation may include roller compaction and extrusion. Roller compaction includes dry blending a formulation and compressing the formulation on a roller compactor. Extrusion includes direct extrusion and indirect extrusion. One method of cold extrusion includes dry blending a formulation, and optionally a binder, and forcing the formulation by a screw or ram through the extruder at 20-24° C. to form an extruded product. The compressed formulation and extruded product may be milled and shifted to achieve the desired particle size.

In wet granulation, solvents and/or binders may be added to a formulation to provide larger aggregates of granules. The temperature during granulation may be set at any suitable point, generally not exceeding the melting point of any components of the formulation. Typically, the mixture is granulated at a temperature of 35-65° C. for 20-90 minutes. Then the granules are typically air dried for a suitable duration, such as, for example, one or more hours.

In various embodiments, the salt composition may be granulated with high shear mixer granulation (“HSG”) or fluid-bed granulation (“FBG”). Both of these processes provide enlarged granules or pellets but differ in the apparatuses used and the mechanism of the process operation. In HSG, blending and wet massing is accomplished by high mechanical agitation by an impeller and a chopper. Mixing, densification, and agglomeration of wetted materials are achieved through shearing and compaction forces exerted by the impeller. The chopper cuts the material into smaller fragments and aids the distribution of the liquid binder. The liquid binder may be poured into a bowl or sprayed onto the material to achieve a more homogeneous liquid distribution.

Fluidization is an operation by which fine solids are transformed into a fluid-like state through contact with a gas. At certain gas velocities, the fluid will support the particles, giving them freedom of mobility without entrainment. Such a fluidized bed resembles a vigorously boiling fluid, with solid particles undergoing extremely turbulent motion, which increases with gas velocity. Fluidized bed granulation is a process by which granules are produced in a fluidized bed by spraying a binder solution onto a fluidized powder bed to form larger granules. The binder solution may be sprayed from one or more spray guns positioned at any suitable manner, e.g., top, bottom, and/or tangential. The spray position and spray rate may relate to the nature of the salt and binder.

In various embodiments, the method may comprise a fluid bed granulation process to prepare the salt composition. A chamber may be charged with the edible, non-salt carrier and first fine salt. These ingredients may be fluidized with hot air. Water may be sprayed into the fluidized particles to cause agglomeration of the carrier and fine salt. After the granules attain the desired particle size, e.g., 100 micrometers to 1500 micrometers, the water may be turned off. Fluidization may continue with hot air until the granules are dry, or have a moisture content less than 5%. In various embodiments, the method may comprise milling and/or sieving to utilize oversized particles and/or remove extra fine particles.

In various embodiments, the method may comprise powder coating the second fine salt onto the core. In various embodiments, the method may comprise a fluid bed granulation process to deposit the coating onto the core. The chamber may be charged with the granulated core particles and second fine salt. As described above, these particles may be fluidized in hot air. Water may be sprayed into the fluidized particles to cause agglomeration of the granulated particles and fine salt. The spray nozzles may be positioned at the top, bottom, and/or tangential to the fluidized particles. The process may be continued until each granulated particle is coated uniformly to the desired coat percentage and/or thickness. The water may be turned off and fluidization may continue with hot air until the agglomerated granules are dry, or have a moisture content less than 5%. In various embodiments, the method may comprise milling and/or sieving to attain the desired particle size, e.g., 100 micrometers to 1500 micrometers. The process may uniformly coat or microencapsulate the individual particles.

In various embodiments, the fluid bed granulation process may be generally characterized by the location of a spray nozzle. As described above, the spray nozzle may be positioned at the bottom, top, and/or tangential to a fluidized bed of solid particles. When the spray nozzle is positioned at the bottom, the particles may move with a fluidizing air stream that is designed to induce a cyclic particle flow upward past the spray nozzle. The nozzle sprays atomized droplets of a coating solution, suspension, or slurry concurrently with particle flow. Passing particles may move upward into an expansion chamber as droplets deposit on their surfaces. The expansion chamber may reduce air velocity to allow particles to circulate back to the coating chamber. It may also allow particles to further separate from one another temporarily and minimize the potential for particle agglomeration and accretion. The coating solution may be evaporated as the particles move into and through the expansion chamber to leave a coating on the surface of the core. In various embodiments, this batch process may be continued until each particle is coated uniformly to the desired coat percentage and/or thickness. The process may uniformly coat or microencapsulate individual particles.

The salt compositions may be used as a substitute for table salt in many applications. For example, the salt compositions may be used as topping salt on foods, or as pretzel salt and popcorn grade salt. The salt compositions may be used in commercial manufacturing processes to salt the exterior of processed foods, e.g., potato chips, pretzels, peanuts, seeds, corn chips, tortilla chips, crackers and bread sticks. The salt compositions may be applied to the foods in amounts effective to provide the saltiness desired. The salt composition may cling or adhere to the food product the same way as natural salt.

Without wishing to be bound to any particular theory, the salt compositions according to various embodiments may provide the desired physical properties of fine salts, e.g., a higher dissolution rate, and deliver them in a form that may achieve higher upfront salt intensity, and linger, while maintaining the granular visual appeal of conventional table salt at a lower salt content. By varying the ratio of co-granulated fine salt and surface deposited fine salt, the dissolution and/or release profile may be modulated to affect saltiness time/intensity at lower salt content. Various embodiments of the salt composition may provide improved efficiency of salty taste to foods at a significantly lower sodium intake.

Without wishing to be bound to any particular theory, the flavor and organoleptic properties of the lower-sodium salt compositions may be improved by the synergistic effect of the particle sizes of the first fine salt and second fine salt, and the ratio of the first fine salt to the second fine salt. The first fine salt and second fine salt work together in a synergistic manner and when present in specific, controlled amounts, even greater improvements in initial salt taste and long lasting salty taste may be obtained. This synergistic effect may be achieved while maintaining other desired properties, such as visual appeal of conventional topical salt formulations.

### Examples

The various embodiments described herein may be better understood when read in conjunction with one or more of the following representative examples. The following examples are included for purposes of illustration and not limitation.

### Example 1: Salt Composition Comprising Lactose and Fine Salt

Fine salt (74 micrometers or 200 mesh) is prepared by fine milling granulated salt in a Waring Blender. 100 g of lactose is dry blended with 65 g of fine salt. The dry blend is loaded into a bench fluid bed coating unit. A binder/coating solution is prepared by dissolving 15 g of fine salt (44 micrometers or 325 mesh), 15 g 1 DE maltodextrin in 150 g DI water. Granulating and coating the blend is carried out by both top and bottom spray fluid bed coating. For the top spray, the coating solution is atomized from a top spray nozzle at slow speed effective to slowly grow the particles and coat the surface. The feed is varied from 1.5 to 3.0 g/minute using a peristaltic pump. Inlet air is 65° C. When all of the coating/binding solution is applied, the run is stopped for evaluation. Particle size is controlled by varying the feed rate. Granulated material may be collected for evaluation. For the bottom spray, the same coating process as used for top spray is used except atomization is carried out from the bottom with a Wurster insert using the Wurster method of particle coating.

The visual appearance of the salt composition is characterized by irregular shaped crystalline granules resembling granulated salt. The particles are very hard and do not break during handling. The taste of the salt composition is a nice salty taste, very clean, with no off taste, and very faint sweetness. The bake stability of the salt composition is stable when baked at a temperature of 250-550° F. for a time of 3-30 minutes on Nabisco Premium saltine crackers. The composition has 100% baked stability without melting, browning or burning. The salt composition maintains original taste before baking.

### Example 2: Tastant Composition Comprising 1 DE Maltodextrin and Fine Salt

The same procedure is followed as in Example 1, except 1 DE maltodextrin is used as the substrate/carrier instead of lactose. The rate of particle growth is slower with 1 DE maltodextrin than with lactose. Particle size is controlled by varying the feed rate. The feed rate is slower than in Example 1. Granulated material collected for evaluation exhibits the same characteristics as the granulated salt composition of Example 1.

The visual appearance of the salt composition is characterized by irregular shaped crystalline granules resembling granulated salt. The strength of the salt composition is very hard and does not break during handling. The taste of the salt composition is a nice salty taste, very clean, no off taste, very faint sweetness. The bake stability of the salt composition is stable when baked on a Saltine or Premium crackers without melting, browning or burning. The salt composition maintains original taste before baking.

### Example 3: Tastant Composition Comprising High DE Maltodextrin and Fine Salt

The same procedure is followed as in Example 2, except high 20 DE maltodextrin is used as the substrate/carrier instead of 1 DE maltodextrin. The salt composition has a noticeable sweetness. The salt composition is not stable when baked. The salt composition melts completely and some degree of browning is noticeable when baked.

### Example 4: Tastant Composition Comprising Corn Syrup and Fine Salt

The same procedure is followed as in Example 2, except corn syrup (40 DE maltodextrin) is used as the substrate/carrier instead of 1 DE maltodextrin. The results are the same at Example 3.

### Example 5: Tastant Composition Comprising Sucrose and Fine Salt

The same procedure is followed as in Example 2, except sucrose is used as the substrate/carrier instead of 1 DE maltodextrin. The results are the same at Example 3.

### Example 6: Tastant Composition Comprising Dextrose and Fine Salt

The same procedure is followed as in Example 2, except dextrose is used as the substrate/carrier instead of 1 DE maltodextrin. The results are the same at Example 3.

### Example 7: Salt Release/Dissolution for Modulating Salty Taste Profile

Three salt compositions having different ratios of fine salt (200 mesh) distributed within granulated particles to fine salt (325 mesh) coated on the surface of the granulated particle are evaluated. The salt compositions are prepared on a pilot plant scale using Granurex granulator and powder layering (GXR 95 manufactured and sold by Freund-Vector). The salt composition comprises 35 weight percent 1 DE maltodextrin as a substrate for forming and delivering salt and 65 weight percent total salt content (including fine 200 salt and fine 325 salt).

TABLE 1
Formulations of granulated salt particles.

| | | % on | | | |
|---|---|---|---|---|---|
| Formu- | % inside | particle | 1DE | Fine salt | Fine salt |
| lation | particles | surface | Maltodextrin | (200 mesh) | (325 mesh) |
| 1 | 25 | 75 | 35 | 20 | 45 |
| 2 | 15 | 85 | 35 | 10 | 55 |
| 3 | 0 | 100 | 35 | 0 | 65 |

The maltodextrin is co-granulated with the fine salt (Fine salt 200 from Morton salt, through a 200 mesh size). The dry blend is loaded into the granulator bowl while mixing by rotating at about 120-150 rpm. A water solution is sprayed onto the dry blend in the granulator bowl at a varying rate to slowly and uniformly grow the granules. Spraying is stopped when the desired particle size is achieved. The granulated particles are dried in fluidizing hot air to achieve a moisture content below 5%.

The granulated particles are powder layered using the same equipment. The granulated particles are rotated at about 150 rpm and a fine salt (Fine salt 325 from Morton salt, through 325 mesh) is slowly and constantly fed through a slit port, and a spray binder solution of water and maltodextrin is fed through a secondary port. While controlling a balanced feed of powder and a binder solution, a uniform coating of the fine salt (325 mesh) is applied to the surface of the granulated particles. Coating is continued until all of the fine salt (325 mesh) is deposited on the surface of the granulated particles. Then, the coated particles are dried to achieve a moisture content below 5%.

During the co-granulation and powder layering, intermittent samples may be analyzed for particle size distribution. The granulated particles and/or coated particles are sifted to remove fines, and overages, and fractions are recombined to match particle size distribution of the control topping salt (Sample 4).

The coated particles (Samples 1-3) and control (Sample 4) have the formulations shown in Table 2 and are analyzed for moisture, salt, and % sodium.

TABLE 2
Formulations of salt compositions.

| | | | Sodium | |
|---|---|---|---|---|
| Sample | Formulation | % salt | (mg/100 g) | % moisture |
| 1 | 1 | 58.47 | 23200 | 3.22 |
| 2 | 2 | 58.43 | 23400 | 2.43 |
| 3 | 3 | 59.10 | 24300 | 3.48 |
| 4 | Control | 97.89 | 35300 | 0 |

As shown in Table 2, the salt compositions according to various embodiments included about 60% salt while the control salt composition included about 97.9% salt.

As shown in FIG. 1, the dissolution rates for the salts compositions are as follows: Formulation (variable) 3>Formulation (variable) 2>Formulation (variable) 1.

### Example 8: Evaluation of Crackers

Premium crackers are used to evaluate salt compositions according to various embodiments. Traditional dough cracker is prepared and sheeted. The salt compositions are dusted or deposited via a salter on the top of conveyed cracker sheets at a rate effective to provide visually acceptable and appealing coverage. The salted cracker sheets are baked through a hot air convection oven to a desired browning and moisture. The salted cracker sheets are collected, cooled, and stored for further evaluation.

The coated crackers and control in Table 3 are analyzed for moisture, salt, and % sodium.

TABLE 3
Crackers coated with salt compositions.

| | | | Sodium | |
|---|---|---|---|---|
| Cracker | Sample | % Salt | (mg/100 g) | % moisture |
| 1A | 1 | 1.18 | 530 | 4.60 |
| 1B | 1 | 1.17 | 517 | 5.69 |
| 1C | 1 | 1.17 | 534 | 4.79 |
| | Average | | 527 | |
| 2A | 2 | 1.40 | 659 | 7.25 |
| 2B | 2 | 1.37 | 621 | 4.49 |
| 2C | 2 | 1.42 | 647 | 4.86 |
| | Average | | 642 | |
| 3A | 3 | 1.41 | 653 | 4.02 |
| 3B | 3 | 1.40 | 652 | 4.22 |
| 3C | 3 | 1.41 | 633 | 4.39 |
| | Average | | 646 | |
| 4A | 4 | 1.76 | 753 | 5.91 |
| 4B | 4 | 1.61 | 694 | 5.92 |
| 4C | 4 | 1.54 | 630 | 5.91 |
| | Average | | 692 | |

A sensory test was conducted with an internal expert sensory panel. Up to 7 panelists participated in this test. The panel evaluated both straight salt and crackers. The scores are relative. The panel concluded that crackers 1-3 demonstrated a very clean salty taste profile and no off taste were noticeable, and the salt intensity was as follows:
cracker 3>cracker 4>cracker 2>>cracker 1.
   Cracker 1 was noticeably lower in intensity than crackers 2-4. Crackers 1-3 has the same appearance and size. The control (cracker 4) had a slightly smaller particle size. Crackers 1-4 were whiter and less translucent than the control, but the whiteness was not objectionable to the panel.

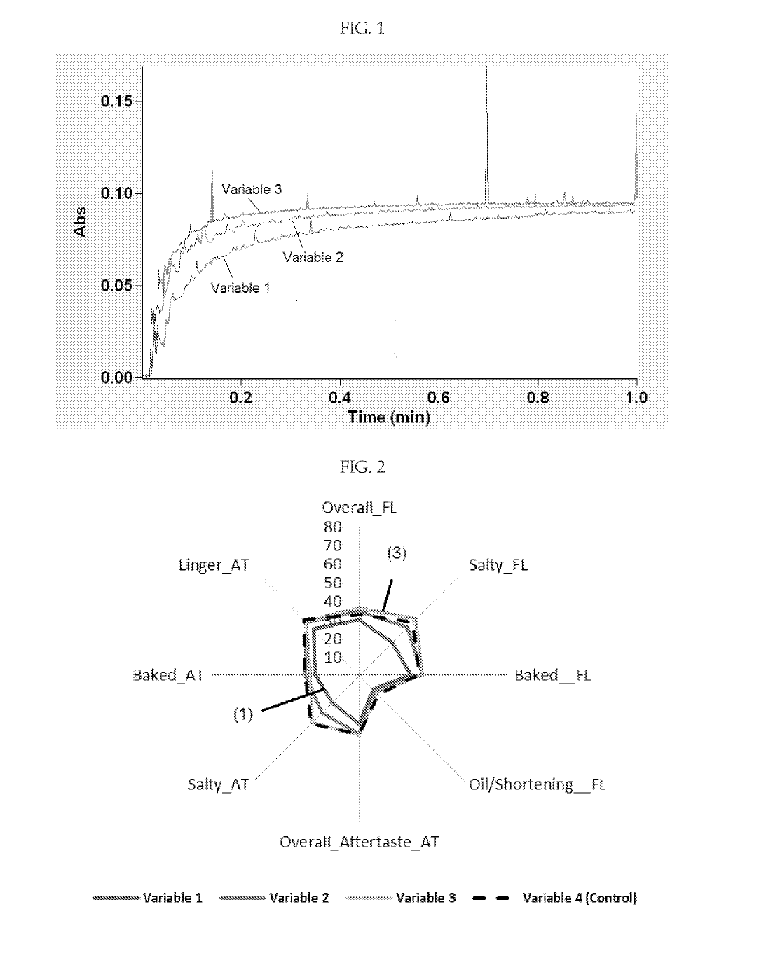

Sensory evaluations were also performed on the samples to assess their organoleptic properties of texture, flavor, and appearance. A sensory test of aged crackers was conducted with an internal expert sensory panel. Up to 12 panelists participated in this test. The panel evaluated crackers 1-4 blindly after about 4 weeks of age. The flavor and aftertaste analyses of crackers 1-4 are shown in FIG. 2. The crackers are evaluated for initial overall flavor, initial salty flavor, initial baked flavor, initial oil/shortening flavor, linger aftertaste, baked aftertaste, salty aftertaste, and overall aftertaste. The scores are relative. Cracker 3 has the highest salt taste intensity for both upfront and linger and demonstrated a stronger salty taste intensity and profile at lower salt and sodium content. Cracker 2 also demonstrated a similar effect, but not as strong as cracker 3.

### Example 9: Dissolution Testing of Salt Compositions

The salt or cracker is added to a stirred solution of mercury (II) thiocyanate (Hg(SCN)₂) in water. The released chloride from the salt reacts to form a UV-absorbing complex with the Hg(SCN)₂. The formation of this complex is monitored at 260 nm using a UV-VIS spectrophotometer.

For cracker analysis, a cracker of each type is selected. The cracker is unbroken and has a generally even distribution of salt on the surface. Each cracker is broken in half and the halves are placed back-to-back; the halves are oriented so that the salted surface faces out on both sides. The two halves are held together with lab forceps for the test.

For the salt replacer analysis, about 15 mg of each salt replacer is weighed onto a weighing paper.

About 10 mL of the saturated Hg(SCN)₂ stock solution is added to a clean 250 mL beaker. About 90 mL of deionized water is added to the beaker with a magnetic stir bar. The solution is stirred on a magnetic stir plate set at 2.5 units on a scale of 7 units. A folded paper towel can be placed between the beaker and the stir plate to prevent or reduce heating of the solution by the stirrer motor.

A fiber optic probe is lowered into the stirring solution, without contacting the stir bar, and the spectrophotometer baseline is zeroed in this solution.

For the crackers, the back-to-back cracker halves are quickly dipped into the stirring solution while simultaneously beginning the acquisition of the UV spectrum at 260 nm using remote start. The crackers are held in place in the solution for the duration of the test while avoiding the rotating stirring bar and fiber optic probe. The crackers are oriented so that the test solution sweeps past the cracker surfaces freely. If using the VARIAN CARY 50 BIO UV/VIS spectrophotometer, the “Kinetics” program is used to acquire the dissolution profile for 1 minute with 0.1 second averaging.

For the salt replacers, acquisition is started using remote start and the sample is dumped into the stirring reagent solution. The acquisition parameters are same as for the crackers.

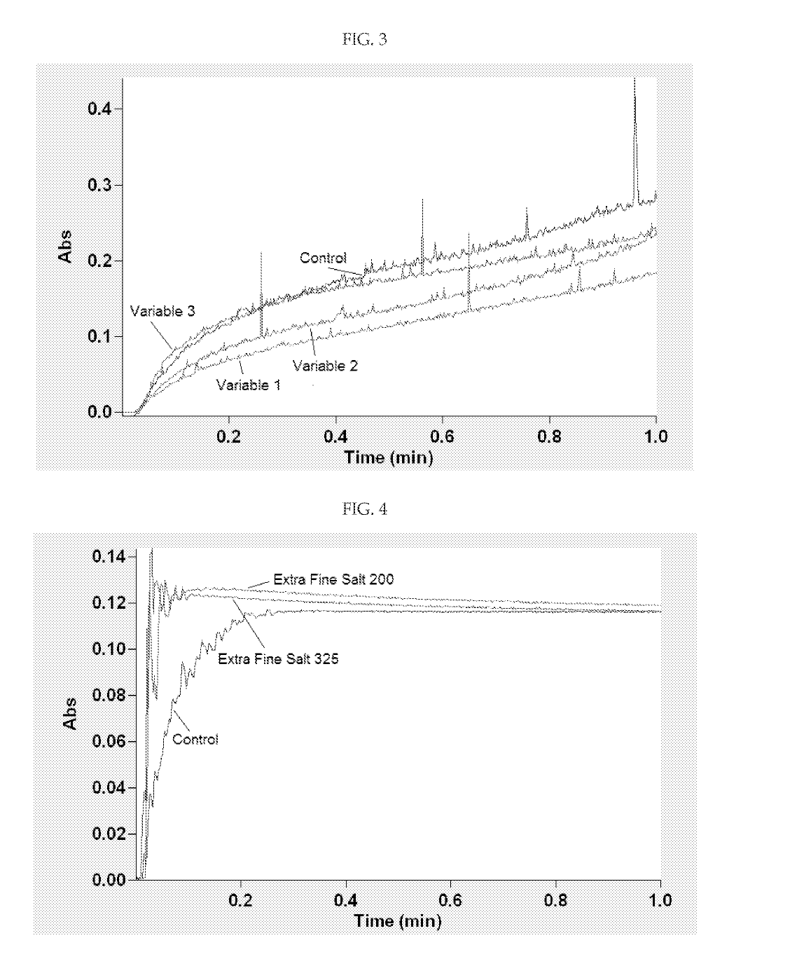

As shown in FIGS. 3 and 4, the dissolution curves generally correlate with the sensory analysis, and support the belief that the first few seconds of snacking (for biscuit) is critical for salty taste perception. Composition 3 has the highest dissolution rate for the initial 10-20 seconds. The dissolution rates for the initial 10-20 seconds may be characterized as follows:
composition 3>composition 4>composition 2>composition 1.

As shown in FIGS. 3 and 4, the salt composition and ratio of surface salt to inside particle salt have an effect on dissolution rate and sensory perception.

All numerical ranges stated herein include all sub-ranges subsumed therein. For example, a range of “1 to 10” is intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

1. A salt composition comprising:
a core including a mixture of an edible, non-salt carrier and a first fine salt; and
a coating on the core, the coating comprising a second fine salt, and optionally a binder.
The composition of claim 1, wherein the composition comprises, based on weight percent of the composition:
up to 95%, up to 90%, or up to 75% edible, non-salt carrier; and
a total salt content of at least 5%, at least 10%, or at least 25%.

3. The composition of claim 1, wherein the first fine salt and second fine salt each comprise sodium chloride particles having a particle size of 44 micrometers to 74 micrometers (200 mesh to 325 mesh), and wherein the average particle size of the first fine salt is greater than the average particle size of the second fine salt.

4. The composition of claim 1, wherein the ratio of the weight of the second fine salt to that of the first fine salt is at least 4:1, and wherein the first fine salt has an average particle size of 74 micrometers (200 mesh) and the second fine salt has an average particle size of 44 micrometers (325 mesh).

5. The composition of claim 1, wherein at least one of the first fine salt and second fine salt individually comprise a mixture of sodium chloride particles having a particle size of 74 micrometers (200 mesh) and 44 micrometers (325 mesh).

6. The composition of claim 3, wherein a ratio of the particles having a particle size of 74 micrometers (200 mesh) to the particles having a particle size of 44 micrometers (325 mesh) is greater than 5:1

7. The composition of claim 1, wherein the ratio of the second fine salt to first fine salt is at least 10:1; the composition has a moisture content of less than 5%; the composition has a particle size of less than 250 micrometers (60 mesh); the composition has a salt intensity on a weight per weight basis that is about the same as a salt intensity of a corresponding composition comprising a greater weight percent of sodium chloride; the composition has an initial dissolution rate that is about the same and a lingering dissolution rate that is less than a dissolution rate of a corresponding composition comprising sodium chloride having a greater average particle size; the composition has about a 100% baked stability as measured by percent of the composition that does not melt, brown, or burn when baked at a temperature of 250-550° F. for a time of 3-30 minutes; and the composition is substantially free from salt potentiators, flavorants, and other salts of organic and non-organic acids, phosphates, citrates, and lactates.

8. A method of making a salt composition comprising:
granulating an edible, non-salt carrier and a first fine salt;
drying the granules to reduce the moisture content to less than 5%;
coating the granules with a second fine salt, and optionally a binder; and
drying the coated granules to reduce the moisture content to less than 5% to obtain the composition;
wherein the average particle size of the first fine salt is greater than the average particle size of the second fine salt; and
wherein the composition comprises,
a core including a mixture of the edible, non-salt carrier and first fine salt, and
a coating on the core, the coating comprising the second fine salt.

9. The method of claim 8 comprising wet granulating the edible, non-salt carrier and first fine salt.

10. The method of claim 8 comprising fluid bed coating the granules with the second fine salt, and optionally the binder, and further comprising removing salt particles having an average particle size up to 50 μm.

11. The method of claim 8 wherein the composition comprises, based on weight percent of the composition:
up to 95%, up to 90%, or up to 75% edible, non-salt carrier; and
a total salt content of at least 5%, at least 10%, or at least 25%.

12. The method of claim 8 wherein the ratio of the second fine salt to first fine salt is 4:1 to 10:1, and wherein the first fine salt and second fine salt each comprise sodium chloride particles having a particle size of 74 micrometers (200 mesh) to 44 micrometers (325 mesh).

13. A tastant composition comprising:
a core including a mixture of an edible, non-salt carrier and a first tastant; and
a coating on the core, the coating comprising a second tastant, and optionally a binder.

14. The composition of claim 13 wherein the composition comprises, based on weight percent of the composition:
up to 95%, up to 90%, or up to 75% edible, non-salt carrier; and
a total tastant content of at least 5%, at least 10%, or at least 25%.

15. The composition of claim 13 wherein the first tastant and second tastant each comprise sodium chloride particles having a particle size of 74 micrometers (200 mesh) to 44 micrometers (325 mesh); the average particle size of the first tastant is greater than the average particle size of the second tastant; and the ratio of the weight of the second tastant to that of the first tastant is at least 4:1.

16. The composition of claim 13 wherein the first tastant has an average particle size of 74 micrometers (200 mesh) and the second tastant has an average particle size of 44 micrometers (325 mesh).

17. The composition of claim 13 wherein at least one of the first tastant and second tastant individually comprise a mixture of sodium chloride particles having a particle size of 74 micrometers (200 mesh) and 44 micrometers (325 mesh).

18. The composition of claim 17 wherein a ratio of the particles having a particle size of 74 micrometers (200 mesh) to the particles having a particle size of 44 micrometers (325 mesh) is greater than 2:1, or greater than 5:1; and the ratio of the second tastant to first tastant is at least 5:1, or at least 10:1.

19. The composition of claim 13, wherein the composition has a moisture content of less than 5%, a particle size of less than 250 micrometers (60 mesh), less tastant per unit volume than an equivalent volume of tastant, and a tastant flavor intensity on a weight per weight basis that is about the same as a flavor intensity of a corresponding composition comprising a greater weight percent of tastant, and the composition has an initial dissolution rate that is about the same and a lingering dissolution rate that is less than a dissolution rate of a corresponding composition comprising a tastant having a greater average particle size, and the composition has about a 100% baked stability as measured by percent of the composition not melting, browning, or burning when baked at a temperature of 250-550° F. for a time of 3-30 minutes.

20. A method of making a tastant composition comprising:
granulating an edible, non-salt carrier and a first tastant;
drying the granules to reduce the moisture content to less than 5%;
coating the granules with a second tastant, and optionally a binder;
drying the coated granules to reduce the moisture content to less than 5% to obtain the composition;
wherein the average particle size of the first tastant is greater than the average particle size of the second tastant; and
wherein the composition comprises,
a core including a mixture of the edible, non-salt carrier and first tastant, and
a coating on the core, the coating comprising the second tastant.

21. The method of claim 20 comprising wet granulating the edible, non-salt carrier and first tastant.

22. The method of claim 20 comprising fluid bed coating the granules with the second tastant, and optionally the binder, and further comprising removing tastant particles having an average particle size up to 50 μm.

23. The method of claim 20, wherein the composition comprises, based on weight percent of the composition:
up to 95%, up to 90%, or up to 75% edible, non-salt carrier; and
a total tastant content of at least 5%, at least 10%, or at least 25%.

24. The method of claim 20 wherein the ratio of the second tastant to first tastant is 4:1 to 10:1, and wherein the first tastant and second tastant each have a particle size of 74 micrometers (200 mesh) to 44 micrometers (325 mesh).

25. (canceled)
